(19) United States
(12) Patent Application Publication
(10) Pub. No.: US 2014/0293501 A1
(43) Pub. Date: Oct. 2, 2014

(54) MULTILAYER CERAMIC CAPACITOR AND METHOD OF MANUFACTURING THE SAME

(71) Applicant: SAMSUNG ELECTRO-MECHANICS CO., LTD., Suwon (KR)

(72) Inventor: Se Hwa JEONG, Suwon (KR)

(73) Assignee: SAMSUNG ELECTRO-MECHANICS CO., LTD.

(21) Appl. No.: 13/946,940

(22) Filed: Jul. 19, 2013

(30) Foreign Application Priority Data
Apr. 2, 2013 (KR) 10-2013-0035794

(51) Int. Cl. H01G 4/30; H01G 4/005

(52) U.S. Cl. CPC H01G 4/30; H01G 4/005
USPC 361/301.4; 29/25.41

(57) ABSTRACT

There is provided a multilayer ceramic capacitor including a ceramic body including a plurality of dielectric layers stacked therein, a plurality of first and second internal electrodes disposed in the ceramic body to be alternately exposed to both end surfaces of the ceramic body, and first and second external electrodes formed on the both end surfaces of the ceramic body and electrically connected to the first and second internal electrodes, respectively, wherein the second internal electrode includes a lead-out portion exposed to one end surface of the ceramic body and a capacitance formation portion overlapped with the first internal electrode, the capacitance formation portion has a length and a width smaller than those of the first internal electrode, and a connection portion connecting the lead-out portion and the capacitance formation portion of the second internal electrode to each other is forced to have a bottleneck shape.

### CROSS-REFERENCE TO RELATED APPLICATIONS

This application claims the priority of Korean Patent Application No. 10-2013-0035794 filed on Apr. 2, 2013, in the Korean Intellectual Property Office, the disclosure of which is incorporated herein by reference.

### BACKGROUND OF THE INVENTION

1. Field of the Invention

The present invention relates to a multilayer ceramic capacitor and a method of manufacturing the same.

2. Description of the Related Art

Since a multilayer ceramic capacitor (MLCC), a multilayer chip electronic component, has advantages such as a small size, high capacitance, ease of mounting, such a multilayer ceramic capacitor may be used in various electronic devices.

For example, the multilayer ceramic capacitor may be used as a chip shaped condenser mounted on the printed circuit hoards of various electronic products such as display devices, including liquid crystal, displays (LCDs), plasma display panels (PDPs), and the like, computers, personal digital assistants (PDA), and mobile phones to serve to charge or discharge electricity.

Particularly, a multilayer ceramic capacitor used for impedance snatching of an electronic circuit needs to have an ultra compact size and ultra-low capacitance characteristics, but only manufactured, goods satisfying a narrow capacitance range with a narrow degree of deviation can he used. Therefore, capacitance distribution is of growing importance. In addition, an improvement in the capacitance distribution is important for high yields.

Generally, the multilayer ceramic capacitor may have a structure in which a plurality of dielectric layers and internal electrodes having different polarities provided between the dielectric layers are alternately disposed.

In this case, the capacitance distribution of the multilayer ceramic capacitor significantly depends on resolution of the internal electrode and precision of a laminator.

Therefore, in order to improve the capacitance distribution of the multilayer ceramic capacitor, a design capable of optimizing the resolution of the internal electrode and the precision of the laminator is required.

A multilayer ceramic capacitor in which first and second internal electrodes are disposed to be offset from each other in a width direction to thereby have portions thereof that are not overlapped with each other in the width direction is disclosed in the following Patent Document 1, but a configuration in which a capacitance formation portion of the second internal electrode has a length and width smaller than those of the first internal electrode such that the first internal electrode has portions that do not overlap the second internal electrode in the length and width directions thereof has not been disclosed. In addition, a multilayer ceramic capacitor in which a lead-out portion of an internal electrode is formed to have a bottleneck shape is disclosed in the following Patent Document 2. However, a multilayer ceramic capacitor capable of improving capacitance distribution is not disclosed in either of Patent Document is 1 and 2.

### RELATED ART DOCUMENT

(Patent Document 1) Japanese Patent Laid-Open Publication No. 2004-022859

(Patent Document 2) Korean Patent No. 10-0587006

### SUMMARY OF THE INVENTION

An aspect of the present invention provides a multilayer ceramic capacitor capable of significantly decreasing a change in an overlapped area even in the case in which resolution distribution of internal electrodes is generated, and easily correcting an alignment defect even in the case that the alignment defect is generated in length and thickness directions daring a stacking process.

According to an aspect of the present invention, there is provided a multilayer ceramic capacitor including: a ceramic body including a plurality of dielectric layers stacked therein; a plurality of first and second internal electrodes disposed, in the ceramic body to be alternately exposed to both end surfaces of the ceramic body, having each dielectric layer interposed therebetween; and first and second external electrodes formed on the both end surfaces of the ceramic body and electrically connected to the first and second internal electrodes, respectively, wherein the second internal electrode includes a lead-cut portion exposed to one end surface of the ceramic body and a capacitance formation portion overlapped with the first internal electrode, the capacitance formation portion has a length, and a width smaller than those of the first internal electrode, and a connection portion connecting the lead-out portion and the capacitance formation portion of the second internal electrode to each other is formed to have a bottleneck shape.

When the width of the capacitance formation portion of the second internal electrode is defined as a and a width of the connection portion of the second internal electrode is defined as b, a ratio (b/a) of the width of the connection portion to the width of the capacitance formation portion may satisfy 0.1≦b/a≦1.0.

When the width of the capacitance formation portion of the second internal electrode is defined as a and the width of the first infernal electrode is defined as c, a ratio (a/c) of the width of the capacitance formation portion of the second internal electrode to the width of the first internal electrode may satisfy 0.1≦a/c≦1.0.

In the second internal electrode, an edge of the capacitance formation portion is curved. In the second internal electrode, an edge of the capacitance formation portion is tapered toward the connection portion.

In the second internal electrode, an edge of the lead-out portion is curved. In the second internal electrode, an edge of the lead-out portion is tapered toward the connection portion.

According to another aspect of the present invention, there is provided a method of manufacturing a multilayer ceramic capacitor, the method including: forming a plurality of electrode patterns including a first conductive pattern and a second conductive pattern having a length and a width smaller than those of the first conductive pattern and connected to the first conductive pattern through a connection pattern having a bottleneck shape on respective ceramic sheets in a length direction, with a predetermined interval therebetween; stacking a plurality of the ceramic sheets including the electrode patterns formed thereon in a thickness direction such that the first and second conductive patterns alternate with each other to prepare a laminate; cutting the laminate for each region corresponding to one capacitor and performing sintering to prepare a ceramic body in such a manner that a portion having the second conductive pattern and the connection pattern is a second internal electrode exposed to one end surface of the laminate, and the remaining portion is a first internal electrode exposed to the other end surface of the laminate, based on a cutting line of the electrode patterns, the first and second internal electrodes being alternately exposed to both end surfaces of the ceramic body; and forming first and second external electrodes on the both end surfaces of the ceramic body to be electrically connected to exposed portions of the first and second internal electrodes, respectively.

In the forming of the electrode patterns, when the width of the second conductive pattern is defined as a and a width of the connection pattern is defined as b, a ratio (b/a) of the width of the connection pattern to the width of the second conductive pattern may satisfy 0.1≦b/a≦1.0.

In the forming of the electrode patterns, when the width of the second conductive pattern is defined as a and the width of the first conductive pattern is defined as c, a ratio (a/c) of the width of the second conductive pattern to the width of the first conductive pattern may satisfy 0.1≦a/c≦1.0.

In the forming of the electrode patterns, an edge of the second conductive pattern may be formed to be curved or tapered toward the connection pattern.

In the forming of the electrode patterns, an edge of the first conductive pattern may be formed to be curved or tapered toward the connection pattern.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a multilayer ceramic capacitor according to an embodiment of the present invention;

FIG. 2 is a cross-sectional view taken along line A-A′ of FIG. 1;

FIG. 3A is a plan view showing a first internal electrode applied to the multilayer ceramic capacitor of FIG. 1;

FIG. 3B is a plan view showing a second internal electrode applied to the multilayer ceramic capacitor of FIG. 1;

FIG. 4A is a plan view showing a first internal electrode applied to a multilayer ceramic capacitor according to another embodiment of the present invention;

FIG. 4B is a plan view showing a second internal electrode applied to a multilayer ceramic capacitor according to another embodiment of the present invention;

FIG. 5 is a plan view showing first and second internal electrodes applied to the multilayer ceramic capacitor of FIG. 1 in a state in which they are put one over another;

FIG. 6 is a plan view schematically showing a state in which a plurality of electrode patterns are formed on a ceramic sheet in a method of manufacturing a multilayer ceramic capacitor according to an embodiment of the present invention; and

FIG. 7 is a plan view showing one of the electrode patterns of FIG. 6.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

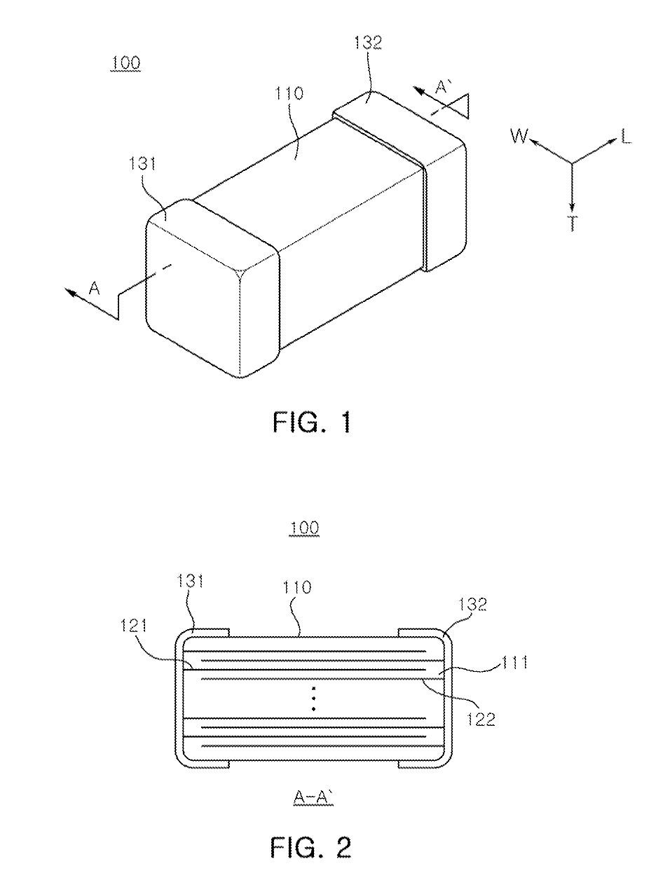

In addition, defining directions in the present invention, L, W, and T directions shown in FIG. 1 refer to a length direction, a width direction, and a thickness direction, respectively.

Multilayer Ceramic Capacitor

FIG. 1 is a perspective view schematically showing a multilayer ceramic capacitor according to an embodiment of the present invention. FIG. 2 is a cross-sectional view taken along line A-A′ of FIG. 1.

Referring to FIGS. 1 and 2, a multilayer ceramic capacitor 100 according to the embodiment of the present invention may include a ceramic body 110 including a plurality of dielectric layers 111 stacked therein, a plurality of first and second internal electrodes 121 and 122, and first and second external electrodes 131 and 132 electrically connected to the first and second internal electrodes 121 and 122, respectively.

The ceramic body 110 may be formed by stacking the plurality of ceramic dielectric layers 111 in the thickness direction and then firing them, wherein dielectric layers 111 may be integrated such that boundaries between adjacent dielectric layers 111 may not be readily apparent. Here, the ceramic body 110 may have a hexahedral shape.

The dielectric layer 111 may contain a ceramic material having a high degree of permittivity, for example, a barium titanate (BaTiO3)-based ceramic powder, or the like, but the present invention is not limited thereto as long as sufficient capacitance may be obtained.

In addition, the dielectric layer 111 may further contain carious ceramic additives such as transitional metal oxides or carbides, a rare earth element, magnesium (Mg), aluminum (Al), or the like, an organic solvent, a plasticizer, a hinder, a dispersant, or the like, as needed, in addition to the ceramic powder.

Referring to FIG. 2, in a length-thickness cross-section of the multilayer ceramic capacitor 100, portions of the multilayer ceramic capacitor 100, in which the first and second internal electrodes 121 and 122 are not formed may be defined as margin portions.

In this case, among the margin portions, margin portions positioned uppermost and lowermost in the thickness direction of the ceramic body 110 may be defined as upper and lower cover layers.

The upper and lower cover layers may be formed by sintering a plurality of ceramic sheets, similarly to the dielectric layer 111 including the first and second internal electrodes 121 and 122 formed thereon and have a similar structure to that of the dielectric layer 111 positioned in a central position of the ceramic body 110 except that the internal electrode is not formed.

Further, referring to FIG. 2, the first and second external electrodes 131 and 132 are formed on both end surfaces of the ceramic body 110 so as to cover the plurality of first internal electrodes 121 and lead-out portions of the second internal electrodes 122 to be described below that are exposed to the both end surfaces of the ceramic body 110, respectively to thereby be electrically connected thereto.

The first and second internal electrodes 131 and 132 as described above may be formed of a conductive metal, for example, at least one of silver (Ag), lead (Pb), platinum (Pt), nickel (Ni), and copper (Cu), an alloy thereof, or the like, but the present invention is not limited thereto.

Meanwhile, first and second plating layers (not shown) may be formed on the first and second external electrodes 131 and 132, as needed.

The first and second plating layers may include a nickel (Ni) plating layer formed on the first and second external electrodes 131 and 132 and a tin (Sn) plating layer formed on the nickel plating layer,

The first and second plating layers as described above are provided to increase adhesive strength between the multilayer ceramic capacitor 100 and a printed circuit board at the time of mounting the multilayer ceramic capacitor 100 on the printed circuit board, or the like, by solder. The plating may be performed by a method known in the art, and lead-free plating may foe performed in consideration of environmental-friendliness, but the present invention is not limited thereto.

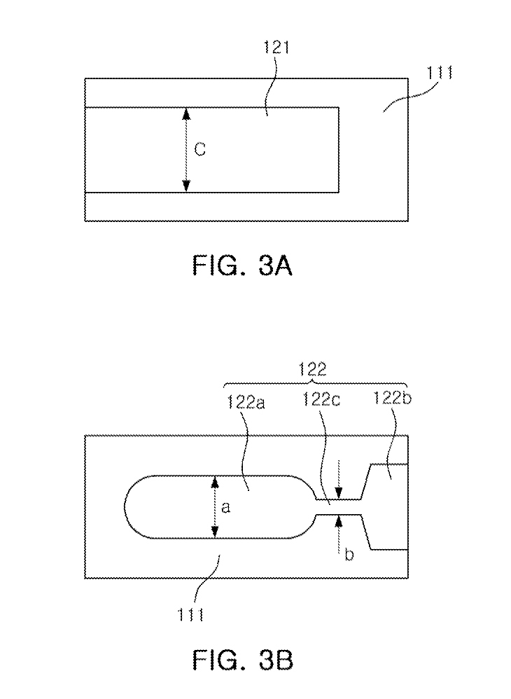

FIG. 3A is a plan view showing the first internal electrode applied to the multilayer ceramic capacitor of FIG. 1, and FIG. 3B is a plan view showing the second internal electrode applied to the multilayer ceramic capacitor of FIG. 1.

Referring to FIGS. 3A and 3B, the first and second internal electrodes 121 and 122, electrodes having different polarities, may be individually formed on at least one surface of a ceramic sheet forming the dielectric layer 111, stacked to one each other, and disposed in the ceramic body 110 to be alternately exposed to both end surfaces of the ceramic body 110, having each dielectric layer 111 therebetween.

In this case, the first and second internal electrodes 121 and 122 may be electrically insulated from each other by the dielectric layer 111 disposed therebetween.

In addition, the first and second internal electrodes 121 and 122 may be formed of a conductive metal, for example, at least one of silver (Ag), lead (Pb), platinum (Pt), nickel (Mi), and copper (Cu), an alloy thereof, or the like, but the present invention is not limited thereto.

Referring to FIG. 3A, the first internal electrode 121 is formed to have a rectangular shape, and one end portion thereof is exposed to one surface of the dielectric layer 111.

Referring to FIG. 3B, the second internal electrode 122 may include a lead-oat portion 122b exposed to the other surface of the dielectric layer 111 and a capacitance formation portion 122a overlapped with the first internal electrode 121, wherein a length and width, that is, the overall area of the capacitance formation portion 122a of the second internal electrode 122 are smaller than those of the first internal electrode 121, respectively.

In addition, the capacitance formation portion 122a and the lead-out portion 122b may be connected to each other through a connection portion 122c, and the connection portion 122c may have a bottleneck shape.

Therefore, due to the structures ox the first and second internal electrodes 121 and 122 as described above, an influence on capacitance distribution due to resolution of the internal electrode and precision of a laminator may be significantly decreased, and even though resolution distribution of the internal electrode is generated, a change in an overlapped area between the first and second internal electrodes 121 and 122 may be significantly decreased.

In this case, when a width of the connection portion 122c overlapped with the first internal electrode 121 is increased, the capacitance distribution may be increased. On the contrary, when the width of the connection portion 122c is decreased, the capacitance distribution may be decreased.

Here, when a width of the capacitance formation portion 122a of the second internal electrode 122 is defined as a and the width of the connection portion 122c of the second internal electrode 122 is defined as b, a ratio (b/a) of the width of the connection portion 122c to the width of the capacitance formation portion 122a may satisfy 0.1≦b/a≦1.0.

In addition, when the width of the capacitance formation portion 122a of the second internal electrode 122 is defined as a and a width of the first internal electrode 121 is defined as c, a ratio (a/c) of the width of the capacitance formation portion 122a of the second internal electrode 122 to the width of the first internal electrode 121 may satisfy 0.1≦a/c≦1.0.

In this case, an edge of the capacitance formation portion 122a of the second internal electrode 122 may be curved, and an edge of the lead-out portion 122b may be formed to a chamfered shape in which the edge is tapered toward the connection pat 122c.

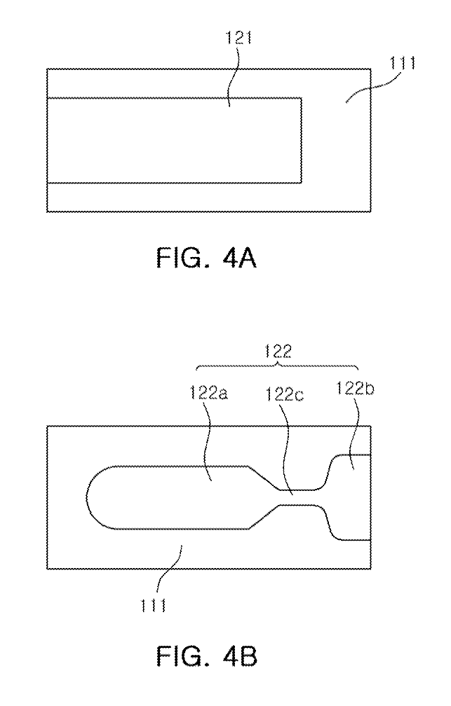

However, the present invention is not limited thereto, but the first and second internal electrodes 121 and 122 may be formed such that the edge of the capacitance formation portion 122a of the second internal electrode 122 is tapered toward the connection portion 122a and the edge of the lead-out portion 122b is curved as shown in FIG. 4B while maintaining the shape of the first internal electrode 121 as shown in FIG. 4A.

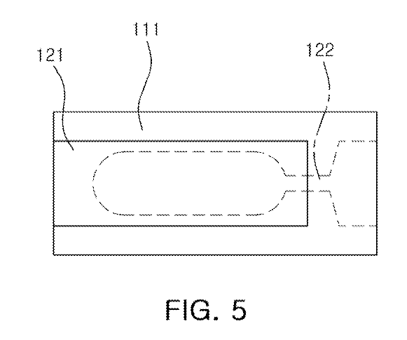

FIG. 5 is a plan view showing first and second internal electrodes applied to the multilayer ceramic capacitor of FIG. 1 in a state in which they are put one over another.

Referring to FIG. 5, the capacitance of the multilayer ceramic capacitor 100 may he in proportion to the overlapped area between the first and second internal electrodes 121 and 122 in a direction in which the dielectric layers 111 are stacked (hereinafter, referred to as “a stacking direction”).

That is, the first and second internal electrodes 121 and 122 may be continuously stacked, in the thickness direction to configure an active region forming capacitance due to the first internal electrode 121 and the capacitance formation portion 122a of the second internal electrode 122 being overlapped with each other in the ceramic body 110 in the stacking direction.

Method of Manufacturing a Multilayer Ceramic Capacitor

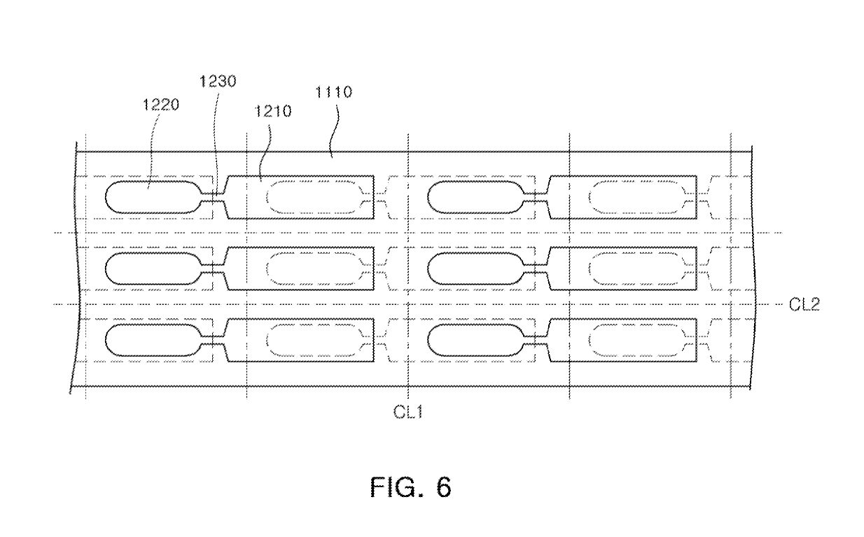

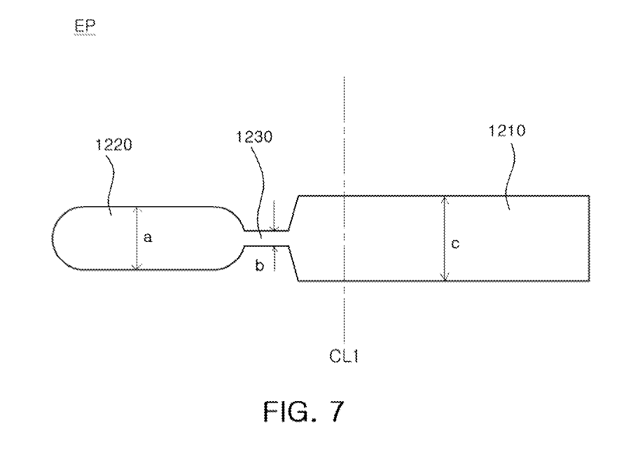

FIG. 6 is a plan view schematically showing a state in which a plurality of electrode patterns are formed on a ceramic sheet in a method of manufacturing a multilayer ceramic capacitor according to an embodiment of the present invention, and FIG. 7 is a plan view showing one of the electrode patterns of FIG. 6.

Hereinafter, the method of manufacturing a multilayer ceramic capacitor according to the embodiment of the present invention will be described with reference to FIGS. 6 and 7.

First, a plurality of ceramic sheets 1110 may be prepared.

The ceramic sheets 1110, provided to form the dielectric layers 111 of the ceramic body 110 arid the upper and lower cover layers of upper and lower margin portions, may be manufactured to have a shape of a sheet having a thickness of several μm by mixing ceramic powders, a polymer, and a solvent to prepare a slurry, applying the prepared slurry to respective carrier films by a doctor blade method, or the like, and drying the applied slurry.

Thereafter, a conductive paste may be printed on at least one surface of the ceramic sheet 1110 at a predetermined thickness to form a plurality of electrode patterns (EP) in the length direction, with a predetermined interval therebetween.

The electrode patterns (EP) may include a first conductive pattern 1210 formed to have an approximately rectangular shape and a second conductive pattern 1220 having a length, a width, and an area smaller than those of the first conductive pattern 1210 and connected to the first conductive pattern 1210 through a connection pattern 1230 having a bottleneck-shape.

In addition, as a method of printing the conductive paste for forming the electrode pattern (EP), a screen printing method, a gravure printing method, or the like, may be used, but the present invention is not limited thereto.

In this case, when a widen of the second conductive pattern 1220 is defined as a and a width of the connection, pattern 1230 is defined as b, a ratio (b/a) of the width of the connection pattern 1230 to the width of the second conductive pattern may satisfy 0.1≦b/a≦1.0.

In addition, when the width of the second conductive pattern 1220 is defined as a and a width of the first conductive pattern 1210 is defined as c, a ratio (a/c) of the width of the second conductive pattern 1220 to the width c of the first conductive pattern 1210 may satisfy 0.1≦a/c≦1.

Next, a plurality of ceramic sheets on which the electrode patterns (EP) are formed may be stacked in the thickness direction in such a manner that the first and second, conductive patterns 1210 and 1220 may alternate with each other and then compressed in the stacking direction, thereby preparing a laminate.

Then, the laminate may be cut for each region corresponding to one capacitor along cutting lines CL1 and CL2 to thereby be formed in a chip form, and the cut chip is sintered at a high temperature, followed by polishing the sintered chip, thereby preparing the ceramic body 110 having the first and second electrodes 121 and 122.

In this case, based on the cutting line of the electrode pattern (EP), a portion having the second conductive pattern 1220 and the connection pattern 1230 may be the capacitance formation portion 122a and the connection portion 122c of the second internal electrode 122 exposed to one end surface of the laminate, the remaining portion may be the first internal electrode 121 exposed to the other end surface of the laminate. A cut portion of the first conductive pattern 1210 that is separated from the first conductive pattern 1210 and does not become the first internal electrode may be the lead-out portion 122b of the second internal electrode 121, and the ceramic body may have a structure in which the first and second internal electrodes 121 and 122 are stacked in the thickness direction to be alternately exposed to both end surfaces of the ceramic body.

Therefore, with the structures of the first and second internal electrodes 121 and 122 as described above, an influence on capacitance distribution due to resolution distribution of the internal electrode and precision of the laminator may be significantly decreased, and even in the case in which resolution distribution of the internal electrode is generated, a change in an overlapped area between the first and second internal electrodes 121 and 122 may be significantly decreased.

Further, even in the case in which an alignment defect between the internal electrodes is generated in length and thickness directions during a process of stacking ceramic sheets, this defect may be easily corrected.

Next, the first and second external electrodes 131 and 132 may be formed to be electrically connected to exposed portions of the first internal electrode 121 and the lead-out portion 122b of the second internal electrode 122 in a thickness-length cross-sect ion of the ceramic body 110, respectively.

In this case, as needed, first and second plating layers (not shown) may be formed by plating surfaces of the first and second external electrodes 131 and 132 using an electro plating method, or the like, after the forming of the first and second external electrodes 131 and 132.

As a material used in the plating process, nickel or tin, a nickel-tin alloy, or the line, maybe used, but the present invention is not limited thereto.

Further, as needed, the first and second plating layers may be formed by sequentially stacking a nickel plating layer and a tin plating layer on the surfaces of the first and second external electrodes 131 and 132.

As set forth above, according to the embodiments of the present invention, even in the case in which resolution distribution between first and second internal electrodes is generated, a change in an overlapped area may be significantly decreased, and even in the case in which an alignment defect is generated in length and thickness directions during a stacking process, the alignment defect may be easily corrected, by forming the second internal, electrode in such a manner that a capacitance formation portion thereof has a length and a width smaller than those of the first internal electrode and forming a connection portion connecting a lead-out portion and the capacitance formation portion of the second internal electrode to have a bottleneck shape, whereby the capacitance distribution of the multilayer ceramic capacitor can be improved and high yields can be implemented.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic capacitor comprising;
a ceramic body including a plurality of dielectric layers stacked therein;
a plurality of first and second internal electrodes disposed, in the ceramic body to foe alternately exposed to both end surfaces of the ceramic body, having each dielectric layer interposed therebetween; and
first and second external electrodes formed on the both end surfaces of the ceramic body and electrically connected to the first and second internal electrodes, respectively,
wherein the second internal electrode includes a lead-out portion exposed to one end surface of the ceramic body and a capacitance formation portion overlapped with the first internal electrode, the capacitance formation portion has a length and a width smaller than those of the first internal electrode, and a connection portion connecting the lead-out portion and the capacitance formation portion of the second internal electrode to each other is formed to have a bottleneck shape.

2. The multilayer ceramic capacitor of claim 1, wherein when the width of the capacitance formation portion of the second internal electrode is defined as a and a width of the connection portion of the second internal electrode is defined as b, a ratio (b/a) of the width of the connection portion to the width of the capacitance formation portion satisfies 0.1≦b/a≦1.0.

3. The multilayer ceramic capacitor of claim 1, wherein when the width of the capacitance formation portion of the second internal electrode is defined as a and the width of the first internal electrode is defined as c, a ratio (a/c) of the width of the capacitance formation portion of the second internal electrode to the width of the first internal electrode satisfies 0.1≦a/c≦1.0.

4. The multilayer ceramic capacitor of claim 1, wherein in the second internal electrode, an edge of the capacitance formation portion is curved.

5. The multilayer ceramic capacitor of claim 1, wherein in the second internal electrode, an edge of the capacitance formation portion is tapered toward the connection portion.

6. The multilayer ceramic capacitor of claim 1, wherein in the second internal electrode, an edge of the lead-out portion is curved.

7. The multilayer ceramic capacitor of claim 1, wherein in the second internal electrode, an edge of the lead-out portion is tapered toward the connection portion.

8. A method of manufacturing a multilayer ceramic capacitor, the method comprising:
forming a plurality of electrode patterns including a first conductive pattern and a second conductive pattern having a length and a width smaller than those of the first conductive pattern and connected to the first conductive pattern through a connection pattern having a bottleneck shape on respective ceramic sheets in a length direction, with a predetermined interval therebetween;
stacking a plurality of the ceramic sheets including the electrode patterns formed thereon in a thickness direction such that the first and second conductive patterns alternate with each other to prepare a laminate;
cutting the laminate for each region corresponding to one capacitor and performing sintering to prepare a ceramic body in such a manner that a portion having the second conductive pattern and the connection pattern is a second internal electrode exposed to one end surface of the laminate, and the remaining portion is a first internal electrode exposed to the other end surface of the laminate, based on a cutting line of the electrode patterns, the first and second internal electrodes being alternately exposed to both end surfaces of the ceramic body; and
forming first and second external electrodes on the both end surfaces of the ceramic body to be electrically connected to exposed portions of the first and second internal electrodes, respectively.

9. The method of claim 8, wherein in the forming of the electrode patterns, when the width of the second conductive pattern is defined as a and a width of the connection pattern is defined as b, a ratio (b/a) of the width of the connection pattern, to the width of the second conductive pattern satisfies 0.1≦b/a≦1.0.

10. The method of claim 8, wherein in the forming of the electrode patterns, when the width of the second conductive pattern is defined as a and the width of the first conductive pattern is defined as c, a ratio (a/c) of the width of the second, conductive pattern to the width of the first conductive pattern satisfies 0.1≦a/c≦1.0.

11. The method of claim 8, wherein in the forming of the electrode patterns, an edge of the second conductive pattern is formed to be curved.

12. The method of claim 8, wherein in the forming of the electrode patterns, an edge of the second conductive pattern is formed to be tapered toward the connection pattern.

13. The method of claim 8, wherein in the forming of the electrode patterns, an edge of the first conductive pattern is formed to be curved.

14. The method of claim 8, wherein in the forming of the electrode patterns, an edge of the first conductive pattern is formed to be tapered toward the connection pattern.
